(19) United States
(12) Patent Application Publication
(10) Pub. No.: US 2009/0245257 A1
(43) Pub. Date: Oct. 1, 2009

(54) Network On Chip

(75) Inventors: Miguel Comparan, Rochester, MN (US); Russell D. Hoover, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/060,559

(22) Filed: Apr. 1, 2008

(51) Int. Cl. H04L 12/28

(52) U.S. Cl. 370/392

(57) ABSTRACT

A network on chip (‘NOC’) that includes integrated processor (‘IP’) blocks, routers, memory communications controllers, and network interface controllers, with all communications including a route code specifying a route through the routers of the NOC from a source to a destination, each router including routing logic that directs a communication to one of four ports of the router, the one port identified by the first two bits in the route code. The routing logic in the router shifts the route code to discard the first two bits of the route code before transmitting the communication through the one port.

### BACKGROUND OF THE INVENTION

1. Field of the Invention

The field of the invention is data processing, or, more specifically apparatus and methods for data processing with a network on chip (‘NOC’).

2. Description Of Related Art

There are two widely used paradigms of data processing; multiple instructions, multiple data (‘MIMD’) and single instruction, multiple data (‘SIMD’). In MIMD processing, a computer program is typically characterized as one or more threads of execution operating more or less independently, each requiring fast random access to large quantities of shared memory. MIMD is a data processing paradigm optimized for the particular classes of programs that fit it, including, for example, word processors, spreadsheets, database managers, many forms of telecommunications such as browsers, for example, and so on.

SIMD is characterized by a single program running simultaneously in parallel on many processors, each instance of the program operating in the same way but on separate items of data. SIMD is a data processing paradigm that is optimized for the particular classes of applications that fit it, including, for example, many forms of digital signal processing, vector processing, and so on.

There is another class of applications, however, including many real-world simulation programs, for example, for which neither pure SIMD nor pure MIMD data processing is optimized. That class of applications includes applications that benefit from parallel processing and also require fast random access to shared memory. For that class of programs, a pure MIMD system will not provide a high degree of parallelism and a pure SIMD system will not provide fast random access to main memory stores.

### SUMMARY OF THE INVENTION

A network on chip (‘NOC’) that includes integrated processor (‘IP’) blocks, routers, memory communications controllers, and network interface controllers, with each IP block adapted to a router through a memory communications controller and a network interface controller, where each memory communications controller controlling communications between an IP block and memory, and each network interface controller controlling inter-IP block communications through routers. In such a NOC, all communications include a route code specifying a route through the routers of the NOC from a source to a destination, and each router includes routing logic that directs a communication to one of four ports of the router, the one port identified by the first two bits in the route code. The routing logic in the router shifts the route code to discard the first two bits of the route code before transmitting the communication through the one port.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in data processing with a NOC according to embodiments of the present invention.

FIG. 2 sets forth a functional block diagram of an example NOC according to embodiments of the present invention.

FIG. 3 sets forth a functional block diagram of a further example NOC according to embodiments of the present invention.

FIG. 4 sets forth a functional block diagram of a further example NOC according to embodiments of the present invention.

FIG. 5 sets forth a flow chart illustrating an exemplary method for data processing with a NOC according to embodiments of the present invention.

FIG. 6 sets forth a flow chart illustrating a further exemplary method for data processing with a NOC according to embodiments of the present invention.

FIG. 7 sets forth a flow chart illustrating a further exemplary method for data processing with a NOC according to embodiments of the present invention.

### DETAILED DESCRIPTION OF EXEMPLARY EMBODIMENTS

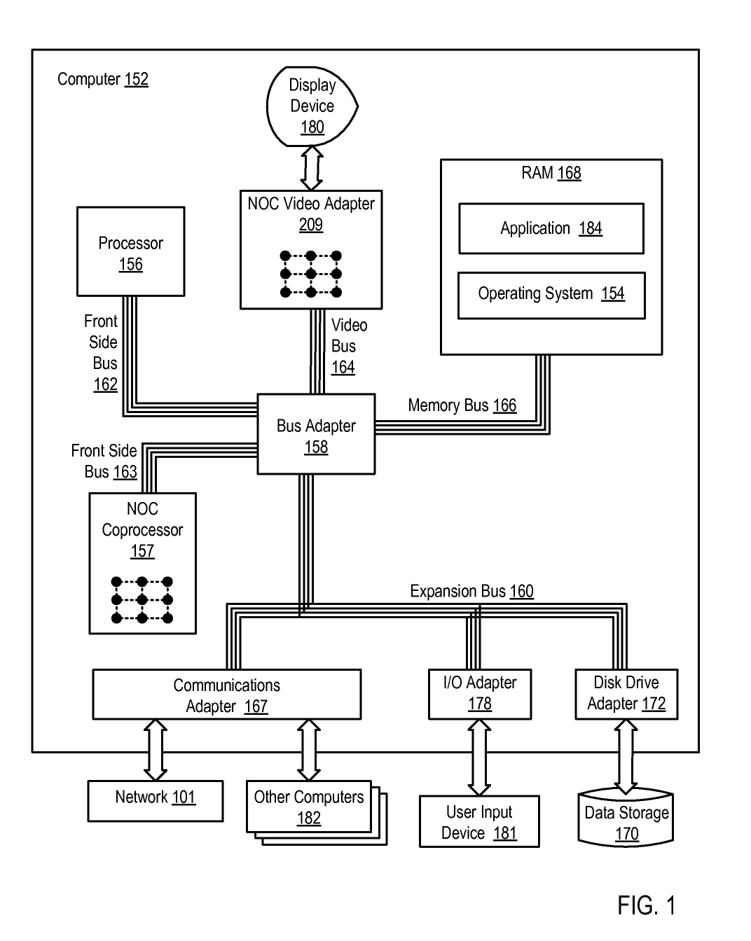

Exemplary apparatus and methods for data processing with a NOC in accordance with the present invention are described with reference to the accompanying drawings, beginning with FIG. 1. FIG. 1 sets forth a block diagram of automated computing machinery comprising an exemplary computer (152) useful in data processing with a NOC according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an application program (184), a module of user-level computer program instructions for carrying out particular data processing tasks such as, for example, word processing, spreadsheets, database operations, video gaming, stock market simulations, atomic quantum process simulations, or other user-level applications. Also stored in RAM (168) is an operating system (154). Operating systems useful data processing with a NOC according to embodiments of the present invention include UNIX™, Linux™, Microsoft XP™, AIX™, IBM's i5/OS™, and others as will occur to those of skill in the art. The operating system (154) and the application (184) in the example of FIG. 1 are shown in RAM (168), but many components of such software typically are stored in non-volatile memory also, such as, for example, on a disk drive (170).

The example computer (152) includes two example NOCs according to embodiments of the present invention: a video adapter (209) and a coprocessor (157). The video adapter (209) is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example NOC coprocessor (157) is connected to processor (156) through bus adapter (158), and front side buses (162 and 163), which is also a high speed bus. The NOC coprocessor of FIG. 1 is optimized to accelerate particular data processing tasks at the behest of the main processor (156).

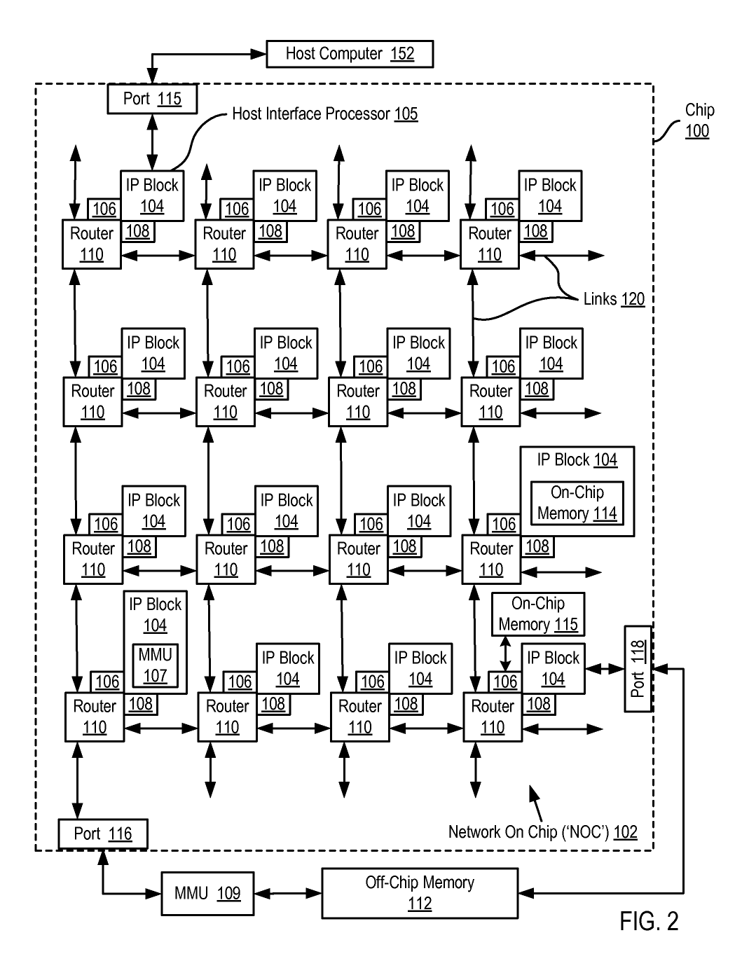

The example NOC video adapter (209) and NOC coprocessor (157) of FIG. 1 each include a NOC according to embodiments of the present invention, including integrated processor (‘IP’) blocks, routers, memory communications controllers, and network interface controllers, each IP block adapted to a router through a memory communications controller and a network interface controller, each memory communications controller controlling communication between an IP block and memory, and each network interface controller controlling inter-IP block communications through routers. In addition in each NOC in the example of FIG. 1, all communications among IP blocks or between IP blocks and memory include a route code specifying a route through the routers of the NOC from a source to a destination, and each router includes routing logic that directs a communication to one of four ports of the router, the one port identified by the first two bits in the route code. The routing logic shifts the route code to discard the first two bits of the route code before transmitting the communication through the one port. The NOC video adapter and the NOC coprocessor are examples of computing apparatus optimized for programs that use parallel processing and also require fast random access to shared memory. The details of NOC structure and operation according to embodiments of the present invention are discussed in more detail below with reference to FIGS. 2-5.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for data processing with a NOC according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for data processing with a NOC according to embodiments of the present invention include modems for wired dial-up communications, Ethernet (IEEE 802.3) adapters for wired data communications network communications, and 802.11 adapters for wireless data communications network communications.

For further explanation, FIG. 2 sets forth a functional block diagram of an example NOC (102) according to embodiments of the present invention. The NOC in the example of FIG. 1 is implemented on a ‘chip’ (100), that is, on an integrated circuit. The NOC (102) of FIG. 2 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110).

In the NOC (102) of FIG. 2, each IP block represents a reusable unit of synchronous or asynchronous logic design used as a building block for data processing within the NOC. The term ‘IP block’ is sometimes expanded as ‘intellectual property block,’ effectively designating an IP block as a design that is owned by a party, that is the intellectual property of a party, to be licensed to other users or designers of semiconductor circuits. In the scope of the present invention, however, there is no requirement that IP blocks be subject to any particular ownership, so the term is always expanded in this specification as ‘integrated processor block.’ IP blocks, as specified here, are reusable units of logic, cell, or chip layout design that may or may not be the subject of intellectual property. IP blocks are logic cores that can be formed as ASIC chip designs or FPGA logic designs.

One way to describe IP blocks by analogy is that IP blocks are for NOC design what a library is for computer programming or a discrete integrated circuit component is for printed circuit board design. In NOCs according to embodiments of the present invention, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHDL. In addition to netlist and synthesizable implementation, NOCs also may be delivered in lower-level, physical descriptions. Analog IP block elements such as SERDES, PLL, DAC, ADC, and so on, may be distributed in a transistor-layout format such as GDSII. Digital elements of IP blocks are sometimes offered in layout format as well.

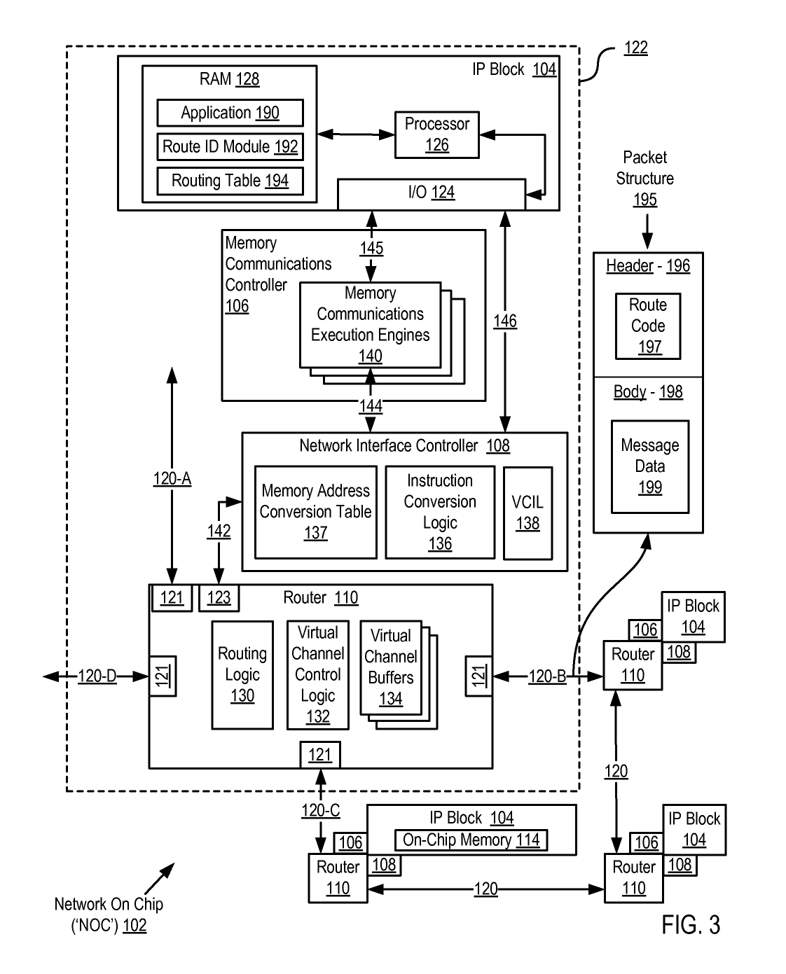

Each IP block (104) in the example of FIG. 2 is adapted to a router (110) through a memory communications controller (106). Each memory communication controller is an aggregation of synchronous and asynchronous logic circuitry adapted to provide data communications between an IP block and memory. Examples of such communications between IP blocks and memory include memory load instructions and memory store instructions. The memory communications controllers (106) are described in more detail below with reference to FIG. 3.

Each IP block (104) in the example of FIG. 2 is also adapted to a router (110) through a network interface controller (108). Each network interface controller (108) controls communications through routers (110) between IP blocks (104). Examples of communications between IP blocks include messages carrying data and instructions for processing the data among IP blocks in parallel applications and in pipelined applications. The network interface controllers (108) are described in more detail below with reference to FIG. 3.

Each IP block (104) in the example of FIG. 2 is adapted to a router (110). The routers (110) and links (120) among the routers implement the network operations of the NOC. The links (120) are packets structures implemented on physical, parallel wire buses connecting all the routers. That is, each link is implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wide, 512 wires. In addition, each link is bidirectional, so that if the link packet structure includes 64 bytes, the wire bus actually contains 1024 wires between each router and each of its neighbors in the network. A message can include more than one packet, but each packet fits precisely onto the width of the wire bus. If the connection between the router and each section of wire bus is referred to as a port, then each router includes five ports, one for each of four directions of data transmission on the network and a fifth port for adapting the router to a single one of the IP blocks, one router to each IP block, through a memory communications controller and a network interface controller.

Each memory communications controller (106) in the example of FIG. 2 controls communications between an IP block and memory. Memory can include off-chip main RAM (112), memory (115) connected directly to an IP block through a memory communications controller (106), on-chip memory enabled as an IP block (114), and on-chip caches. In the NOC of FIG. 2, either of the on-chip memories (114, 115), for example, may be implemented as on-chip cache memory. All these forms of memory can be disposed in the same address space, physical addresses or virtual addresses, true even for the memory attached directly to an IP block. Memory addressed messages therefore can be entirely bidirectional with respect to IP blocks, because such memory can be addressed directly from any IP block anywhere on the network. Memory (114) on an IP block can be addressed from that IP block or from any other IP block in the NOC. Memory (115) attached directly to a memory communication controller can be addressed by the IP block that is adapted to the network by that memory communication controller—and can also be addressed from any other IP block anywhere in the NOC.

In addition in the NOC (102) in the example of FIG. 2, all communications among IP blocks (104) or between IP blocks and memory (112, 114, 115) include a route code specifying a route through the routers of the NOC from a source to a destination, and each router (110) includes routing logic that directs a communication to one of four ports of the router, the one port identified by the first two bits in the route code. The routing logic shifts the route code to discard the first two bits of the route code before transmitting the communication through the one port.

The example NOC includes two memory management units (‘MMUs’) (107, 109), illustrating two alternative memory architectures for NOCs according to embodiments of the present invention. MMU (107) is implemented with an IP block, allowing a processor within the IP block to operate in virtual memory while allowing the entire remaining architecture of the NOC to operate in a physical memory address space. The MMU (109) is implemented off-chip, connected to the NOC through a data communications port (116). The port (116) includes the pins and other interconnections required to conduct signals between the NOC and the MMU, as well as sufficient intelligence to convert message packets from the NOC packet format to the bus format required by the external MMU (109). The external location of the MMU means that all processors in all IP blocks of the NOC can operate in virtual memory address space, with all conversions to physical addresses of the off-chip memory handled by the off-chip MMU (109).

In addition to the two memory architectures illustrated by use of the MMUs (107, 109), data communications port (118) illustrates a third memory architecture useful in NOCs according to embodiments of the present invention. Port (118) provides a direct connection between an IP block (104) of the NOC (102) and off-chip memory (112). With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port (118). The port (118) includes the pins and other interconnections required to conduct signals between the NOC and the off-chip memory (112), as well as sufficient intelligence to convert message packets from the NOC packet format to the bus format required by the off-chip memory (112).

In the example of FIG. 2, one of the IP blocks is designated a host interface processor (105). A host interface processor (105) provides an interface between the NOC and a host computer (152) in which the NOC may be installed and also provides data processing services to the other IP blocks on the NOC, including, for example, receiving and dispatching among the IP blocks of the NOC data processing requests from the host computer. A NOC may, for example, implement a video graphics adapter (209) or a coprocessor (157) on a larger computer (152) as described above with reference to FIG. 1. In the example of FIG. 2, the host interface processor (105) is connected to the larger host computer through a data communications port (115). The port (115) includes the pins and other interconnections required to conduct signals between the NOC and the host computer, as well as sufficient intelligence to convert message packets from the NOC to the bus format required by the host computer (152). In the example of the NOC coprocessor in the computer of FIG. 1, such a port would provide data communications format translation between the link structure of the NOC coprocessor (157) and the protocol required for the front side bus (163) between the NOC coprocessor (157) and the bus adapter (158).

For further explanation, FIG. 3 sets forth a functional block diagram of a further example NOC according to embodiments of the present invention. The example NOC of FIG. 3 is similar to the example NOC of FIG. 2 in that the example NOC of FIG. 3 is implemented on a chip (100 on FIG. 2), and the NOC (102) of FIG. 3 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110). In addition in the NOC (102) in the example of FIG. 3, all communications among IP blocks (104) or between IP blocks and memory (128) include a route code specifying a route through the routers of the NOC from a source to a destination, and each router (110) includes routing logic (130) that directs a communication to one of four ports of the router (121, 123), the one port identified by the first two bits in the route code. The routing logic (130) shifts the route code to discard the first two bits of the route code before transmitting the communication through the one port. In the example of FIG. 3, one set (122) of an IP block (104) adapted to a router (110) through a memory communications controller (106) and network interface controller (108) is expanded to aid a more detailed explanation of their structure and operations. All the IP blocks, memory communications controllers, network interface controllers, and routers in the example of FIG. 3 are configured in the same manner as the expanded set (122).

In the example of FIG. 3, each IP block (104) includes a computer processor (126) and I/O functionality (124). In this example, computer memory is represented by a segment of random access memory (‘RAM’) (128) in each IP block (104). The memory, as described above with reference to the example of FIG. 2, can occupy segments of a physical address space whose contents on each IP block are addressable and accessible from any IP block in the NOC. The processors (126), I/O capabilities (124), and memory (128) on each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention.

Also in the example of FIG. 3, each IP block includes a computer software application (190), a user-level computer software program that, among other things, uses the data communications resources of the NOC to issue memory communications instructions for communications between an IP block and computer memory, particularly computer memory not located locally on an issuing IP block, as well as inter-IP block communications. Each IP block also includes a route identification module (192) and a routing table (194) for use in formulating inter-IP block communications. Each routing table (194) associates route codes and destination network addresses. A route code specifies a route through the routers of the NOC from a source to a destination as a sequence of port numbers or port identifiers. In inter-IP block communications the source is a sending IP block, and the destination is a receiving IP block. Each IP block is associated with a network address, but communications in this example do not include destination network addresses. Instead, each communication is fashioned with a route code that is used by routers of the NOC to guide communications through the NOC from a source to a destination. The route identification module (192) in this example operates to accept a destination network address for a communication from an application program (190) executing on the IP block, find a route code for the communication in the routing table (194), and return the route code to the application program for inclusion in a communication.

FIG. 3 includes an illustration of an example structure (195) of a communications packet on the NOC containing a route code (197) in its packet header (196) and message data (199) in its body (198), but which contains no destination network address whatsoever. In at least some embodiments of a NOC according to embodiments of the present invention, the bus width on the links (120) between routers (110) is the same as the communications packet length, so making a route code (197) part of the packet structure (195) is the same as saying that some of the wires in the bus are now used for a route code.

An example of a route code that specifies a route through the routers of the NOC from a source to a destination as a sequence of port numbers or port identifiers is the binary sequence 00011011. The binary sequence 00011011 specifies a sequence of two-bit port numbers, port 00, port 01, port 10, and port 11. Readers will note that each router in the example of FIG. 3 includes five ports, four ports (121) connecting each router to four neighboring routers and a fifth port (123) connecting each router through its network interface controller to its memory communications controller and its IP block. Two binary bits cannot uniquely encode the identities of five ports, but only two bits are needed here because the routing logic (130) is configured so that a communication is never transmitted back through the port through which the communication arrived in the router. In this way, only four ports are ever eligible to be given an outgoing transmission, and only two binary bits are needed to encode the identity of an eligible port. If a communication is received in the router through port (123) from the router's associated IP block, then only the four ports (120) connecting to neighboring routers are eligible for the communication. If a communication is received in the router through one of the ports (120) connecting to neighboring routers, then only the other three ports to other routers plus the port (123) to the associated network interface connector are eligible for the communication, and the communication is only delivered outbound through port (123) if the receiving router's IP block is the destination of the communication.

The binary sequence 00011011 specifies a route through the routers of the NOC by, first, advising the source router, the router associated with an IP block that sends a communication, that the source router is to transmit the communication through its port number 00, then the router that receives the communication from the source router transmits the communication through its port number 01, the next router transmits through its port 10, a fourth router transmits through its port 11, and the destination router receives the communication through its port that is connected through a link to the fourth router's port 11.

In the example of the route code 00011011, each router in turn shifts the route code to discard the first two bits before transmitting the communication through a port of any particular router. The source router receives the communication containing the route code from its associated IP block and notes from the first two bits of the route code that the source router is to transmit through port 00. Before transmitting, however, the source router shifts the route code to discard the first two bits. When the second router receives the route code, the route code is in the form 011011. The second router notes from the first two bits that the second router is to transmit through port 01, and, before transmitting, the second router shifts the route code to again discard the first two bits in the route code, yielding the route code 1011. The third router notes from the first two bits of the route code 1011 that the third router is to transmit through port 10, and, before transmitting, the third router shifts the route code to again discard the first two bits in the route code, yielding the route code 11. The fourth router notes from the first two bits of the route code 11 that the fourth router is to transmit through port 11, and, before transmitting, the fourth router shifts the route code to again discard the first two bits in the route code, yielding a null route code. The destination router interprets a null route code as an indication that the communication is intended for the destination router and passes the message to its IP block through its network interface controller.

An alternative method of identifying a destination is to use a hop count. The route code includes a hop count for a route from a source to a destination that identifies the number of routers in the route, including the source router and the destination router. Each router in the route between the source and the destination decrements the hop count before transmitting a communication to the next router on the route. When a router receives a communication with its hop count set to one, that communication has reached its destination. Other methods of determining when a communication has reached its destination will occur to those of skill in the art, and all such methods are well within the scope of the present invention.

In the NOC (102) of FIG. 3, each memory communications controller (106) includes a plurality of memory communications execution engines (140). Each memory communications execution engine (140) is enabled to execute memory communications instructions from an IP block (104), including bidirectional memory communications instruction flow (142, 144, 145) between the network and the IP block (104). The memory communications instructions executed by the memory communications controller may originate, not only from the IP block adapted to a router through a particular memory communications controller, but also from any IP block (104) anywhere in the NOC (102). That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions.

Each memory communications execution engine (140) is enabled to execute a complete memory communications instruction separately and in parallel with other memory communications execution engines. The memory communications execution engines implement a scalable memory transaction processor optimized for concurrent throughput of memory communications instructions. The memory communications controller (106) supports multiple memory communications execution engines (140) all of which run concurrently for simultaneous execution of multiple memory communications instructions. A new memory communications instruction is allocated by the memory communications controller (106) to a memory communications engine (140) and the memory communications execution engines (140) can accept multiple response events simultaneously. In this example, all of the memory communications execution engines (140) are identical. Scaling the number of memory communications instructions that can be handled simultaneously by a memory communications controller (106), therefore, is implemented by scaling the number of memory communications execution engines (140).

In the NOC (102) of FIG. 3, each network interface controller (108) is enabled to convert communications instructions from command format to network packet format for transmission among the IP blocks (104) through routers (110). The communications instructions are formulated in command format by the IP block (104) or by the memory communications controller (106) and provided to the network interface controller (108) in command format. The command format is a native format that conforms to architectural register files of the IP block (104) and the memory communications controller (106). The network packet format is the format required for transmission through routers (110) of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In the NOC (102) of FIG. 3, each IP block is enabled to send memory-address-based communications to and from memory through the IP block's memory communications controller and then also through its network interface controller to the network. A memory-address-based communication is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller (106) to an associated network interface controller (108) for conversion (136) from command format to packet format and transmission through the network in a message. In converting to packet format, the network interface controller (108) also identifies a route code for the packet in dependence upon the memory address or addresses to be accessed by a memory-address-based communication. Memory address based messages are addressed with memory addresses. Each memory-address-based communication, in command format and addressed with only a memory address, is provided to a network interface controller (108) by a memory communications controller (106). Such a memory address typically corresponds to a network location of a memory communications controller (106) responsible for some range of physical memory addresses. The network location of a memory communication controller (106) is naturally also the network location of that memory communication controller's associated router (110), network interface controller (108), and IP block (104). In this example, such conversion logic is represented by instruction conversion logic (136) within each network interface controller (108) that is capable of converting memory addresses to route codes for purposes of transmitting memory-address-based communications through the routers of a NOC. In the example of FIG. 3, each network interface controller (108) includes a memory address conversion table (137) that associates memory addresses and route codes, as well as the conversion logic (136) that operates to retrieve from the memory address conversion table (137), in dependence upon a memory address for a communication between an IP block and memory, a route code identifying a route through the network to the memory address. The conversion logic (136) looks up the route code for a memory address for a particular communication in the memory address conversion table and inserts the route code in the memory-address-based communication for use by routers in guiding the communication through the NOC to its destination. After converting to packet format and inserting the route code, the network interface controller hands off the memory-address-based communication through port (123) of its associated router for transmission through the network to its destination.

Upon receiving message traffic from routers (110) of the network, each network interface controller (108) inspects each packet for memory instructions. Each packet containing a memory instruction is handed to the memory communications controller (106) associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In the NOC (102) of FIG. 3, each IP block (104) is enabled to bypass its memory communications controller (106) and send inter-IP block communications (146) directly to the network through the IP block's network interface controller (108). Inter-IP block communications are messages directed, by a network address converted to a route code, from one IP block to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through its I/O functions (124) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142) such communications to and from an associated router, and each network interface controller is enabled to both send and receive (146) such communications directly to and from an associated IP block, bypassing an associated memory communications controller (106).

Each network interface controller (108) in the example of FIG. 3 is also enabled to implement virtual channels on the network, characterizing network packets by type. Each network interface controller (108) includes virtual channel implementation logic (‘VCIL’) (138) that classifies each communication instruction by type and records the type of instruction in a field of the network packet format before handing off the instruction in packet form to a router (110) for transmission on the NOC. Examples of communication instruction types include inter-IP block network-address-based messages, request messages, responses to request messages, invalidate messages directed to caches; memory load and store messages; and responses to memory load messages, and so on.

Each router (110) in the example of FIG. 3 includes routing logic (130), virtual channel control logic (132), and virtual channel buffers (134). The routing logic typically is implemented as a network of synchronous and asynchronous logic that implements a data communications protocol stack for data communication in the network formed by the routers (110), links (120), and bus wires among the routers. The routing logic (130) includes the functionality that readers of skill in the art might associate in off-chip networks with protocol stacks such as the well know TCP/IP, protocol stacks that in at least some embodiments would be considered too slow and cumbersome for use in a NOC. Routing logic (130) is implemented as a network of synchronous and asynchronous logic and can be configured to make routing decisions in as little as a single clock cycle. The routing logic in this example routes packets by selecting a port for forwarding each packet received in a router. Each packet contains a route code that identifies the router port to which the packet is to be routed in each router in route between a source and a destination. Each router in this example includes five ports, four ports (121) connected through bus wires (120-A, 120-B, 120-C, 120-D) to other routers and a fifth port (123) connecting each router to its associated IP block (104) through a network interface controller (108) and a memory communications controller (106). The operation of the routing logic (130) by comparison with tradition protocol stacks is simple, fast, and cost effective: direct an incoming packet for outgoing transmission through the one port identified by the first two digits of the packet's route code and then shift the route code to discard the first two bits of the route code before transmitting the communication through the one port so identified.

In describing memory-address-based communications above, each memory address was described as mapped by network interface controllers to a route code that specifies a route through the routers of the NOC from a source to a destination, the destination being a network location of a memory communications controller. The network location of a memory communication controller (106) is naturally also the network location of that memory communication controller's associated router (110), network interface controller (108), and IP block (104). In inter-IP block, or network-address-based communications, therefore, it is also typical for application-level data processing to view a network address as the location of an IP block within the network formed by the routers, links, and bus wires of the NOC. The NOC of FIG. 2 is an example that illustrates the fact that one organization of such a network is a mesh of rows and columns in which each network address can be implemented, for example, as either a unique identifier for each set of associated router, IP block, memory communications controller, and network interface controller of the mesh or x,y coordinates of each such set in the mesh.

In the NOC (102) of FIG. 3, each router (110) implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router (110) in the example of FIG. 3 also includes virtual channel control logic (132) and virtual channel buffers (134). The virtual channel control logic (132) examines each received packet for its assigned communications type and places each packet in an outgoing virtual channel buffer for that communications type for transmission through a port to a neighboring router on the NOC.

Each virtual channel buffer (134) has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer (134) in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller (108). Each network interface controller is configured to, upon receipt of such a signal, refuse to accept, from its associated memory communications controller (106) or from its associated IP block (104), communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 3. When a router encounters a situation in which a packet might be dropped in some unreliable protocol such as, for example, the Internet Protocol, the routers in the example of FIG. 3 suspend by their virtual channel buffers (134) and their virtual channel control logic (132) all transmissions of packets in a virtual channel until buffer space is again available, eliminating any need to drop packets. The NOC of FIG. 3, therefore, implements highly reliable network communications protocols with an extremely thin layer of hardware.

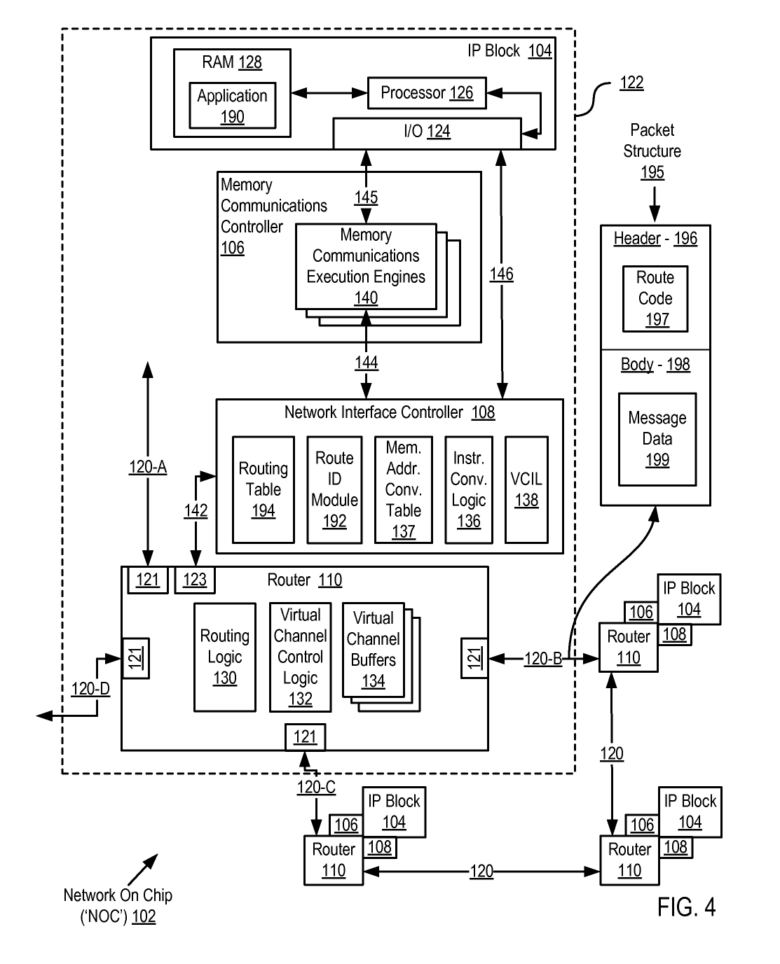

For further explanation, FIG. 4 sets forth a functional block diagram of a further example NOC according to embodiments of the present invention. In summary, the example of FIG. 4 illustrates an alternative NOC architecture in which a routing table (194) and a route identification module (192) are implemented in a network interface controller (106) rather than in the IP block (104) as they were in the example of FIG. 3. The example NOC of FIG. 4 is similar to the example NOCs of FIGS. 2 and 3 in that the example NOC of FIG. 4 is implemented on a chip (100 on FIG. 2), and the NOC (102) of FIG. 4 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller (106) controls communications between an IP block and memory, and each network interface controller (108) controls inter-IP block communications through routers (110). In addition in the NOC (102) in the example of FIG. 4, all communications among IP blocks (104) or between IP blocks and memory (128) include a route code specifying a route through the routers of the NOC from a source to a destination, and each router (110) includes routing logic (130) that directs a communication to one of four ports of the router (121, 123), the one port identified by the first two bits in the route code. The routing logic (130) shifts the route code to discard the first two bits of the route code before transmitting the communication through the one port. In the example of FIG. 4, one set (122) of an IP block (104) adapted to a router (110) through a memory communications controller (106) and network interface controller (108) is expanded to aid a more detailed explanation of their structure and operations. All the IP blocks, memory communications controllers, network interface controllers, and routers in the example of FIG. 4 are configured in the same manner as the expanded set (122).

In the example of FIG. 4, each IP block (104) includes a computer processor (126) and I/O functionality (124). In this example, computer memory is represented by a segment of random access memory (‘RAM’) (128) in each IP block (104). The memory, as described above with reference to the example of FIG. 2, can occupy segments of a physical address space whose contents on each IP block are addressable and accessible from any IP block in the NOC. The processors (126), I/O capabilities (124), and memory (128) on each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention. Also in the example of FIG. 3, each IP block includes a computer software application (190), a user-level computer software program that, among other things, uses the data communications resources of the NOC to issue memory communications instructions for communications between an IP block and computer memory, particularly computer memory not located locally on an issuing IP block, as well as inter-IP block communications.

In the NOC (102) of FIG. 4, each memory communications controller (106) includes a plurality of memory communications execution engines (140). Each memory communications execution engine (140) is enabled to execute memory communications instructions from an IP block (104), including bidirectional memory communications instruction flow (142, 144, 145) between the network and the IP block (104). The memory communications instructions executed by the memory communications controller may originate, not only from the IP block adapted to a router through a particular memory communications controller, but also from any IP block (104) anywhere in the NOC (102). That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions.

Each memory communications execution engine (140) is enabled to execute a complete memory communications instruction separately and in parallel with other memory communications execution engines. The memory communications execution engines implement a scalable memory transaction processor optimized for concurrent throughput of memory communications instructions. The memory communications controller (106) supports multiple memory communications execution engines (140) all of which run concurrently for simultaneous execution of multiple memory communications instructions. A new memory communications instruction is allocated by the memory communications controller (106) to a memory communications engine (140) and the memory communications execution engines (140) can accept multiple response events simultaneously. In this example, all of the memory communications execution engines (140) are identical. Scaling the number of memory communications instructions that can be handled simultaneously by a memory communications controller (106), therefore, is implemented by scaling the number of memory communications execution engines (140).

In the NOC (102) of FIG. 4, each network interface controller (108) is enabled to convert communications instructions from command format to network packet format for transmission among the IP blocks (104) through routers (110). The communications instructions are formulated in command format by the IP block (104), that is, by the application program (190) in the IP block, or by the memory communications controller (106), and provided to the network interface controller (108) in command format. The command format is a native format that conforms to architectural register files of the IP block (104) and the memory communications controller (106). The network packet format is the format required for transmission through routers (110) of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

Each network interface controller in the example of FIG. 4 also includes a route identification module (192) and a routing table (194) for use in formulating inter-IP block communications. Each routing table (194) associates route codes and destination network addresses. A route code specifies a route through the routers of the NOC from a source to a destination as a sequence of port numbers or port identifiers. In inter-IP block communications the source is a sending IP block, and the destination is a receiving IP block. Each IP block is associated with a network address, but communications in this example do not include destination network addresses. Instead, each communication is fashioned with a route code that is used by routers of the NOC to guide communications through the NOC from a source to a destination. In formulating inter-IP block communications, the application program (190) provides each communication with a destination network address and then sends the communication to the network interface controller for translation into packet format. Upon receiving such a communication in command format from the application program in the IP block, the route identification module (192) in the network interface controller operates as conversion logic to retrieve from the routing table (194), in dependence upon the destination network address for the inter-IP block communication, a route code identifying a route through the network to the destination network address for inclusion in the inter-IP block communication.

FIG. 4 includes an illustration of an example structure (195) of a communications packet on the NOC containing a route code (197) in its packet header (196) and message data (199) in its body (198), but which contains no destination network address whatsoever. In at least some embodiments of a NOC according to embodiments of the present invention, the bus width on the links (120) between routers (110) is the same as the communications packet length, so making a route code (197) part of the packet structure (195) is the same as saying that some of the wires in the bus are now used for a route code.

The structure and operation of the route code is explained here for the example of FIG. 4 with the same example route code used in the explanation of the example NOC illustrated and explained above with reference to FIG. 3: An example of a route code that specifies a route through the routers of the NOC from a source to a destination as a sequence of port numbers or port identifiers is the binary sequence 00011011. The binary sequence 00011011 specifies a sequence of two-bit port numbers, port 00, port 01, port 10, and port 11. Readers will note that each router in the example of FIG. 3 includes five ports, four ports (121) connecting each router to four neighboring routers and a fifth port (123) connecting each router through its network interface controller to its memory communications controller and its IP block. Two binary bits cannot uniquely encode the identities of five ports, but only two bits are needed here because the routing logic (130) is configured so that a communication is never transmitted back through the port through which the communication arrived in the router. In this way, only four ports are ever eligible to be given an outgoing transmission, and only two binary bits are needed to encode the identity of an eligible port. If a communication is received in the router through port (123) from the router's associated IP block, then only the four ports (120) connecting to neighboring routers are eligible for the communication. If a communication is received in the router through one of the ports (120) connecting to neighboring routers, then only the other three ports to other routers plus the port (123) to the associated network interface connector are eligible for the communication, and the communication is only delivered outbound through port (123) if the receiving router's IP block is the destination of the communication.

The binary sequence 00011011 specifies a route through the routers of the NOC by, first, advising the source router, the router associated with an IP block that sends a communication, that the source router is to transmit the communication through its port number 00, then the router that receives the communication from the source router transmits the communication through its port number 01, the next router transmits through its port 10, a fourth router transmits through its port 11, and the destination router receives the communication through its port that is connected through a link to the fourth router's port 11.

In the example of the route code 00011011, each router in turn shifts the route code to discard the first two bits before transmitting the communication through a port of any particular router. The source router receives the communication containing the route code from its associated IP block and notes from the first two bits of the route code that the source router is to transmit through port 00. Before transmitting, however, the source router shifts the route code to discard the first two bits. When the second router receives the route code, the route code is in the form 011011. The second router notes from the first two bits that the second router is to transmit through port 01, and, before transmitting, the second router shifts the route code to again discard the first two bits in the route code, yielding the route code 1011. The third router notes from the first two bits of the route code 1011 that the third router is to transmit through port 10, and, before transmitting, the third router shifts the route code to again discard the first two bits in the route code, yielding the route code 11. The fourth router notes from the first two bits of the route code 11 that the fourth router is to transmit through port 11, and, before transmitting, the fourth router shifts the route code to again discard the first two bits in the route code, yielding a null route code. The destination router interprets a null route code as an indication that the communication is intended for the destination router and passes the message to its IP block through its network interface controller.

An alternative method of identifying a destination is to use a hop count. The route code includes a hop count for a route from a source to a destination that identifies the number of routers in the route, including the source router and the destination router.

Each router in the route between the source and the destination decrements the hop count before transmitting a communication to the next router on the route. When a router receives a communication with its hop count set to one, that communication has reached its destination. Other methods of determining when a communication has reached its destination will occur to those of skill in the art, and all such methods are well within the scope of the present invention.

In the NOC (102) of FIG. 4, each IP block is enabled to send memory-address-based communications to and from memory through the IP block's memory communications controller and then also through its network interface controller to the network. A memory-address-based communications is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller (106) to an associated network interface controller (108) for conversion (136) from command format to packet format and transmission through the network in a message. In converting to packet format, the network interface controller (108) also identifies a route code for the packet in dependence upon the memory address or addresses to be accessed by a memory-address-based communication. Memory address based messages are addressed with memory addresses. Each memory-address-based communication, in command format and addressed with only a memory address, is provided to a network interface controller (108) by a memory communications controller (106). Such a memory address typically corresponds to a network location of a memory communications controller (106) responsible for some range of physical memory addresses. The network location of a memory communication controller (106) is naturally also the network location of that memory communication controller's associated router (110), network interface controller (108), and IP block (104). In this example, such conversion logic is represented by instruction conversion logic (136) within each network interface controller (108) that is capable of converting memory addresses to route codes for purposes of transmitting memory-address-based communications through the routers of a NOC. In the example of FIG. 3, each network interface controller (108) includes a memory address conversion table (137) that associates memory addresses and route codes, as well as the conversion logic (136) that operates to retrieve from the memory address conversion table (137), in dependence upon a memory address for a communication between an IP block and memory, a route code identifying a route through the network to the memory address. The conversion logic (136) looks up the route code for a memory address for a particular communication in the memory address conversion table and inserts the route code in the memory-address-based communication for use by routers in guiding the communication through the NOC to its destination. After converting to packet format and inserting the route code, the network interface controller hands off the memory-address-based communication through port (123) of its associated router for transmission through the network to its destination.

Upon receiving message traffic from routers (110) of the network, each network interface controller (108) inspects each packet for memory instructions. Each packet containing a memory instruction is handed to the memory communications controller (106) associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In the NOC (102) of FIG. 4, each IP block (104) is enabled to bypass its memory communications controller (106) and send inter-IP block, network-addressed communications (146) directly to the network through the IP block's network interface controller (108). Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through it I/O functions (124) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142) such communications to and from an associated router, and each network interface controller is enabled to both send and receive (146) such communications directly to and from an associated IP block, bypassing an associated memory communications controller (106).

Each network interface controller (108) in the example of FIG. 4 is also enabled to implement virtual channels on the network, characterizing network packets by type. Each network interface controller (108) includes virtual channel implementation logic (138) that classifies each communication instruction by type and records the type of instruction in a field of the network packet format before handing off the instruction in packet form to a router (110) for transmission on the NOC. Examples of communication instruction types include inter-IP block network-address-based messages, request messages, responses to request messages, invalidate messages directed to caches; memory load and store messages; and responses to memory load messages, and so on.

Each router (110) in the example of FIG. 3 includes routing logic (130), virtual channel control logic (132), and virtual channel buffers (134). The routing logic typically is implemented as a network of synchronous and asynchronous logic that implements a data communications protocol stack for data communication in the network formed by the routers (110), links (120), and bus wires among the routers. The routing logic (130) includes the functionality that readers of skill in the art might associate in off-chip networks with protocol stacks such as the well know TCP/IP, protocol stacks that in at least some embodiments would be considered too slow and cumbersome for use in a NOC. Routing logic (130) is implemented as a network of synchronous and asynchronous logic and can be configured to make routing decisions in as little as a single clock cycle. The routing logic in this example routes packets by selecting a port for forwarding each packet received in a router. Each packet contains a route code that identifies the router port to which the packet is to be routed in each router in route between a source and a destination. Each router in this example includes five ports, four ports (121) connected through bus wires (120-A, 120-B, 120-C, 120-D) to other routers and a fifth port (123) connecting each router to its associated IP block (104) through a network interface controller (108) and a memory communications controller (106). The operation of the routing logic (130) by comparison with tradition protocol stacks is simple, fast, and cost effective: direct an incoming packet for outgoing transmission through the one port identified by the first two digits of the packet's route code and then shift the route code to discard the first two bits of the route code before transmitting the communication through the one port so identified.

In describing memory-address-based communications above, each memory address was described as mapped by network interface controllers to a route code that specifies a route through the routers of the NOC from a source to a destination, the destination being a network location of a memory communications controller. The network location of a memory communication controller (106) is naturally also the network location of that memory communication controller's associated router (110), network interface controller (108), and IP block (104). In inter-IP block, or network-address-based communications, therefore, it is also typical for application-level data processing to view a network address as the location of an IP block within the network formed by the routers, links, and bus wires of the NOC. The NOC of FIG. 2 is an example that illustrates the fact that one organization of such a network is a mesh of rows and columns in which each network address can be implemented, for example, as either a unique identifier for each set of associated router, IP block, memory communications controller, and network interface controller of the mesh or x,y coordinates of each such set in the mesh.

In the NOC (102) of FIG. 4, each router (110) implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router (110) in the example of FIG. 4 also includes virtual channel control logic (132) and virtual channel buffers (134). The virtual channel control logic (132) examines each received packet for its assigned communications type and places each packet in an outgoing virtual channel buffer for that communications type for transmission through a port to a neighboring router on the NOC.

Each virtual channel buffer (134) has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer (134) in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller (108). Each network interface controller is configured to, upon receipt of such a signal, refuse to accept, from its associated memory communications controller (106) or from its associated IP block (104), communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 4. When a router encounters a situation in which a packet might be dropped in some unreliable protocol such as, for example, the Internet Protocol, the routers in the example of FIG. 4 suspend by their virtual channel buffers (134) and their virtual channel control logic (132) all transmissions of packets in a virtual channel until buffer space is again available, eliminating any need to drop packets. The NOC of FIG. 4, therefore, implements highly reliable network communications protocols with an extremely thin layer of hardware.

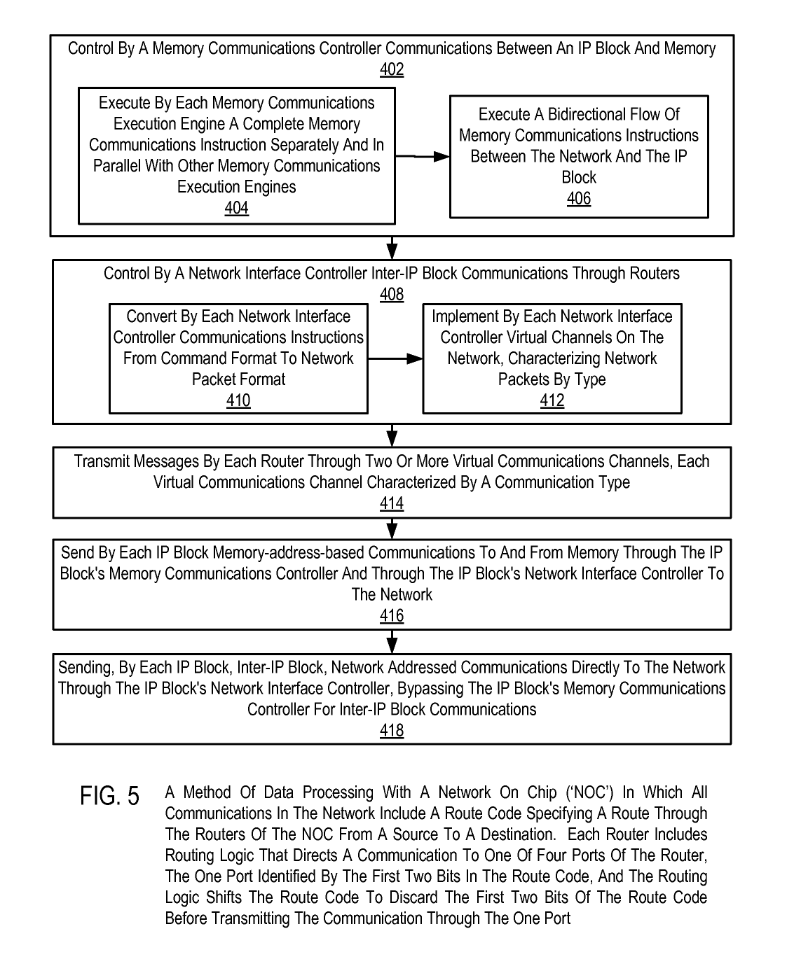

For further explanation, FIG. 5 sets forth a flow chart illustrating an exemplary method for data processing with a NOC according to embodiments of the present invention. The method of FIG. 5 is implemented on a NOC similar to the ones described above in this specification, a NOC (102 on FIG. 4) that is implemented on a chip (100 on FIG. 4) with IP blocks (104 on FIG. 4), routers (110 on FIG. 4), memory communications controllers (106 on FIG. 4), and network interface controllers (108 on FIG. 4). Each IP block (104 on FIG. 4) is adapted to a router (110 on FIG. 4) through a memory communications controller (106 on FIG. 4) and a network interface controller (108 on FIG. 4). In the method of FIG. 5, each IP block may be implemented as a reusable unit of synchronous or asynchronous logic design used as a building block for data processing within the NOC.

The flow chart of FIG. 5 illustrates a method of data processing with a NOC in which all communications in the network include a route code specifying a route through the routers (110 on FIGS. 2, 3, and 4) of the NOC from a source to a destination, and each router includes routing logic (130 on FIGS. 3 and 4) that directs a communication to one of four ports (121, 123 on FIGS. 3 and 4) of the router. The one port to which a communication is to be directed is identified by the first two bits in the route code, and the routing logic shifts the route code to discard the first two bits of the route code before transmitting the communication through the one port to which the communication is directed.

The method of FIG. 5 includes controlling (402) by a memory communications controller (106 on FIG. 4) communications between an IP block and memory. In the method of FIG. 5, the memory communications controller includes a plurality of memory communications execution engines (140 on FIG. 4). Also in the method of FIG. 5, controlling (402) communications between an IP block and memory is carried out by executing (404) by each memory communications execution engine a complete memory communications instruction separately and in parallel with other memory communications execution engines and executing (406) a bidirectional flow of memory communications instructions between the network and the IP block. In the method of FIG. 5, memory communications instructions may include translation lookaside buffer control instructions, cache control instructions, barrier instructions, memory load instructions, and memory store instructions. In the method of FIG. 5, memory may include off-chip main RAM, memory connected directly to an IP block through a memory communications controller, on-chip memory enabled as an IP block, and on-chip caches.

The method of FIG. 5 also includes controlling (408) by a network interface controller (108 on FIG. 4) inter-IP block communications through routers. In the method of FIG. 5, controlling (408) inter-IP block communications also includes converting (410) by each network interface controller communications instructions from command format to network packet format and implementing (412) by each network interface controller virtual channels on the network, including characterizing network packets by type.

The method of FIG. 5 also includes transmitting (414) messages by each router (110 on FIG. 4) through two or more virtual communications channels, where each virtual communications channel is characterized by a communication type. Communication instruction types, and therefore virtual channel types, include, for example: inter-IP block network-address-based messages, request messages, responses to request messages, invalidate messages directed to caches; memory load and store messages; and responses to memory load messages, and so on. In support of virtual channels, each router also includes virtual channel control logic (132 on FIG. 4) and virtual channel buffers (134 on FIG. 4). The virtual channel control logic examines each received packet for its assigned communications type and places each packet in an outgoing virtual channel buffer for that communications type for transmission through a port to a neighboring router on the NOC.

The method of FIG. 5 also includes sending (416) by each IP block (104 on FIGS. 2, 3, and 4) memory-address-based communications to and from memory through the IP block's memory communications controller (105 on FIGS. 2, 3, and 4) and through the IP block's network interface controller (108 on FIGS. 2, 3, and 4) to the network. In a NOC (102 on FIGS. 2, 3, and 4) that supports the method of FIG. 5, each IP block is enabled to send memory-address-based communications to and from memory through the IP block's memory communications controller and then also through its network interface controller to the network. A memory-address-based communication is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

The method of FIG. 5 also includes sending (418), by each IP block (104 on FIGS. 2, 3, and 4), inter-IP block communications directly to the network through the IP block's network interface controller (108 on FIGS. 2, 3, and 4), bypassing (146 on FIGS. 3 and 4) the IP block's memory communications controller (106 on FIGS. 2, 3, and 4) for inter-IP block communications. In a NOC (102 on FIGS. 2, 3, and 4) that supports the method of FIG. 5, each IP block is enabled to bypass its memory communications controller and send inter-IP block communications directly to the network through the IP block's network interface controller. As described above, inter-IP block communications are messages directed, by a network address converted to a route code, from one IP block to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through its I/O functions (124 on FIGS. 3 and 4) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142 on FIGS. 3 and 4) such communications to and from an associated router, and each network interface controller is enabled to both send and receive (146 on FIGS. 3 and 4) such communications directly to and from an associated IP block, bypassing an associated memory communications controller.

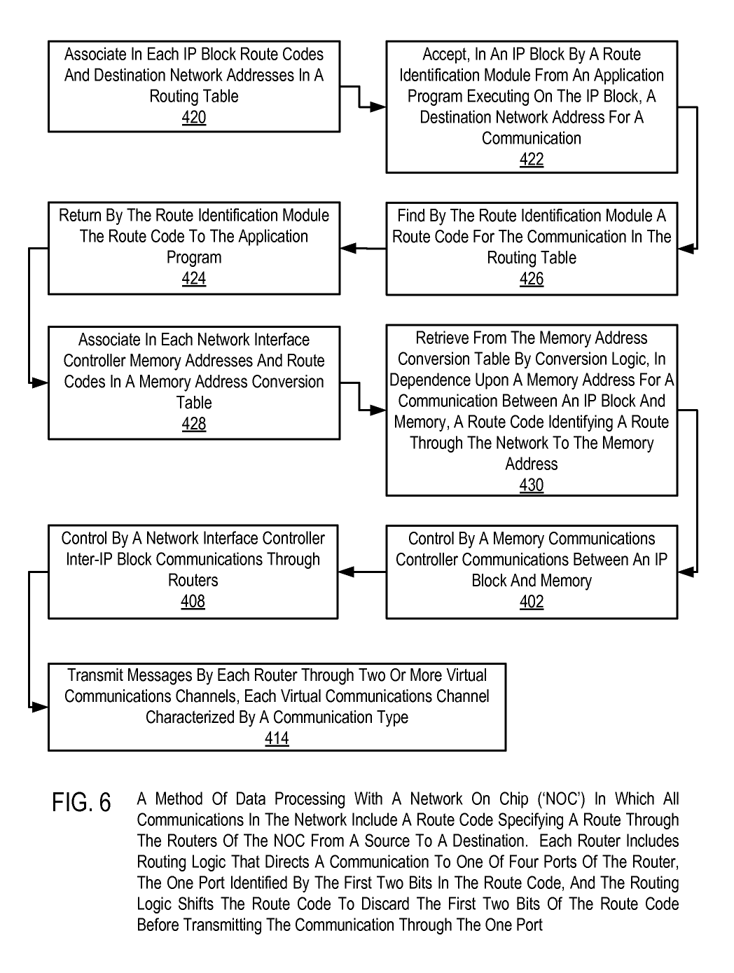

For further explanation, FIG. 6 sets forth a flow chart illustrating a further exemplary method for data processing with a NOC according to embodiments of the present invention. The method of FIG. 6, like the method of FIG. 5, is implemented on a NOC similar to the ones described above in this specification, a NOC (102 on FIG. 4) that is implemented on a chip (100 on FIG. 4) with IP blocks (104 on FIG. 4), routers (110 on FIG. 4), memory communications controllers (106 on FIG. 4), and network interface controllers (108 on FIG. 4). Each IP block (104 on FIG. 4) is adapted to a router (110 on FIG. 4) through a memory communications controller (106 on FIG. 4) and a network interface controller (108 on FIG. 4). In the method of FIG. 6, each IP block may be implemented as a reusable unit of synchronous or asynchronous logic design used as a building block for data processing within the NOC.

The flow chart of FIG. 6, like the flow chart of FIG. 5, illustrates a method of data processing with a NOC in which all communications in the network include a route code specifying a route through the routers (110 on FIGS. 2, 3, and 4) of the NOC from a source to a destination, and each router includes routing logic (130 on FIGS. 3 and 4) that directs a communication to one of four ports (121, 123 on FIGS. 3 and 4) of the router. The one port to which a communication is to be directed is identified by the first two bits in the route code, and the routing logic shifts the route code to discard the first two bits of the route code before transmitting the communication through the one port to which the communication is directed.

The method of FIG. 6 is similar to the method of FIG. 5, including as it does controlling (402) by a memory communications controller communications between an IP block and memory, controlling (408) by a network interface controller inter-IP block communications through routers; and transmitting (414) messages by each router through two or more virtual communications channels, where each virtual communications channel is characterized by a communication type, all of which function as described above with reference to FIG. 5.

In addition, however, the method of FIG. 6 also includes associating (420) in each IP block route codes and destination network addresses in a routing table. Such a routing table may take the form illustrated here in Table 1, for example:

TABLE 1
Example Routing Table

| Network Address | Route Code |
|---|---|
| 0 | 10101010 |
| 1 | 11011101 |
| 2 | 01101101 |
| 3 | 10110010 |
| 4 | null |
| 5 | 01010101 |
| 6 | 11011011 |
| 7 | 11011111 |
| 8 | 11111011 |
| 9 | 11001111 |
| 10 | 11000111 |
| 11 | 11110001 |
| 12 | 11010111 |
| 13 | 11001111 |
| 14 | 00001111 |
| 15 | 11110000 |

Table 1 shows an example of routing table in which each record of the table associates a route code with a network address for one of sixteen IP blocks organized in a NOC with sixteen routers, sixteen network interface controllers, and sixteen memory communications controllers. Such a set of IP blocks and routers could, for example, be organized in a network as a four-by-four matrix, with each set of a router and an IP block identified with one of the sixteen network addresses from the first column of Table 1. Readers will recognize also that the use of the example of sixteen is selected for ease of explanation, not as a limitation of the present invention. In fact, NOCs according to embodiments of the present invention may have any number of IP blocks and routers as may occur to those of skill in the art. Table 1 is an example of a routing table for a particular one of the IP blocks in a NOC with sixteen IP blocks, so that the network addresses in the first column of Table 1 represent destination network addresses for communications from the particular IP block to all the other IP blocks. In this example, the particular IP block served by Table 1 is the IP block located at network address ‘4,’ and that fact is commemorated by setting to ‘null’ the route code for network address ‘4.’

In using routing tables similar to Table 1, each IP block or router in the NOC is configured with a routing table having route codes that are different from the route codes in all the other routing tables in the NOC, because the routes to other IP blocks are different for each IP block in the NOC. An alternative implementation for the routing table would be to configure each IP block with exactly the same routing table. Such a routing table would have a third column to identify a source address, and such a routing table would have, in this example, 256 rows, sixteen rows for each of the sixteen IP blocks in the NOC. Other implementations of the routing table may occur to those of skill in the art, and all such implementation are well within the scope of the present invention.

The method of FIG. 6 also includes accepting (422), in an IP block by a route identification module from an application program executing on the IP block, a destination network address for a communication; finding (424) by the route identification module a route code for the communication in the routing table; and returning (426) by the route identification module the route code to the application program. In a NOC that supports the method of FIG. 6 according to embodiments of the present invention, each IP block includes a computer software application (190 on FIG. 3), a user-level computer software program that, among other things, uses the data communications resources of the NOC to issue memory communications instructions for, among other things, inter-IP block communications. Each IP block includes a route identification module (192) and a routing table (194 on FIG. 3) for use in formulating inter-IP block communications. Each routing table (194 on FIG. 3) associates route codes and destination network addresses. A route code specifies a route through the routers of the NOC from a source to a destination as a sequence of port numbers or port identifiers. In inter-IP block communications the source is a sending IP block, and the destination is a receiving IP block. Each IP block is associated with a network address, but communications in this kind of NOC do not include destination network addresses. Instead, each communication is fashioned with a route code that is used by routers of the NOC to guide communications through the NOC from a source to a destination.

The method of FIG. 6 also includes associating (428) in each network interface controller memory addresses and route codes in a memory address conversion table. The method of FIG. 6 also includes retrieving (430) from the memory address conversion table by conversion logic, in dependence upon a memory address for a communication between an IP block and memory, a route code identifying a route through the network to the memory address. In a NOC that supports the method of FIG. 6, many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller (106 on FIG. 3) to an associated network interface controller (108 on FIG. 3) for transmission through the network in a message. The network interface controller (108) identifies a route code for a communications packet in dependence upon the memory address or addresses to be accessed by a memory-address-based communication. Memory address based messages are addressed with memory addresses. Each memory-address-based communication, in command format and addressed with only a memory address, is provided to a network interface controller (108 on FIG. 3) by a memory communications controller (106 on FIG. 3). Such a memory address typically corresponds to a network location of a memory communications controller responsible for some range of physical memory addresses. The network location of a memory communication controller is naturally also the network location of that memory communication controller's associated router, network interface controller, and IP block. In this example, such conversion logic is represented by instruction conversion logic (136 on FIGS. 3 and 4) within each network interface controller that is capable of converting memory addresses to route codes for purposes of transmitting memory-address-based communications through the routers of a NOC. In such a NOC, each network interface controller includes a memory address conversion table (137 on FIGS. 3 and 4) that associates memory addresses and route codes, as well as the conversion logic (136 on FIGS. 3 and 4) that operates to retrieve from the memory address conversion table, in dependence upon a memory address for a communication between an IP block and memory, a route code identifying a route through the network to the memory address. The conversion logic (136 on FIGS. 3 and 4) looks up the route code for a memory address for a particular communication in the memory address conversion table and inserts the route code in the memory-address-based communication for use by routers in guiding the communication through the NOC to its destination. After converting to packet format and inserting the route code, the network interface controller hands off the memory-address-based communication through port (123 on FIGS. 3 and 4) of its associated router for transmission through the network to its destination.

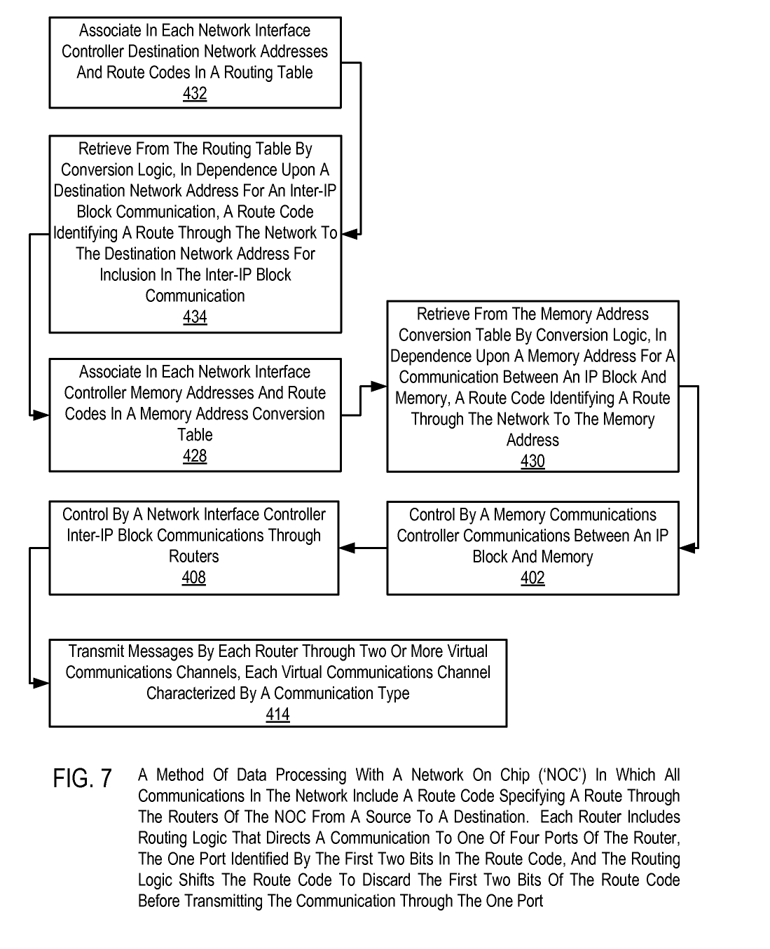

For further explanation, FIG. 7 sets forth a flow chart illustrating a further exemplary method for data processing with a NOC according to embodiments of the present invention. The example method of FIG. 7 is implemented on a NOC similar to the one described above with reference to FIG. 4, a NOC in which a routing table (194 on FIG. 4) and a route identification module (192 on FIG. 4) are implemented in a network interface controller (106 on FIG. 4) rather than in the IP block (104 on FIG. 3) as they were in the example of FIG. 3. The method of FIG. 7, like the methods of FIGS. 5 and 6, is implemented on a NOC (102 on FIG. 4) that is implemented on a chip (100 on FIG. 4) with IP blocks (104 on FIG. 4), routers (110 on FIG. 4), memory communications controllers (106 on FIG. 4), and network interface controllers (108 on FIG. 4). Each IP block (104 on FIG. 4) is adapted to a router (110 on FIG. 4) through a memory communications controller (106 on FIG. 4) and a network interface controller (108 on FIG. 4). In the method of FIG. 7, each IP block may be implemented as a reusable unit of synchronous or asynchronous logic design used as a building block for data processing within the NOC.

The flow chart of FIG. 7, like the flow charts of FIGS. 5 and 6, illustrates a method of data processing with a NOC in which all communications in the network include a route code specifying a route through the routers (110 on FIG. 4) of the NOC from a source to a destination, and each router includes routing logic (130 on FIG. 4) that directs a communication to one of four ports (121, 123 on FIG. 4) of the router. The one port to which a communication is to be directed is identified by the first two bits in the route code, and the routing logic shifts the route code to discard the first two bits of the route code before transmitting the communication through the one port to which the communication is directed.

The method of FIG. 7 is similar to the methods of FIGS. 5 and 6, including as it does controlling (402) by a memory communications controller communications between an IP block and memory, controlling (408) by a network interface controller inter-IP block communications through routers; and transmitting (414) messages by each router through two or more virtual communications channels, where each virtual communications channel is characterized by a communication type, all of which function as described above with reference to FIG. 5.

In addition, however, the method of FIG. 7 also includes associating (432) in each network interface controller destination network addresses and route codes in a routing table. And the method of FIG. 7 also includes retrieving (434) from the routing table by conversion logic, in dependence upon a destination network address for an inter-IP block communication, a route code identifying a route through the network to the destination network address for inclusion in the inter-IP block communication. In a NOC that supports the method of FIG. 7, each network interface controller includes a route identification module (192 on FIG. 4) and a routing table (194 on FIG. 4) for use in formulating inter-IP block communications. Each routing table, as illustrated in Table 1 above, associates route codes and destination network addresses. A route code specifies a route through the routers of the NOC from a source to a destination as a sequence of port numbers or port identifiers. In inter-IP block communications the source is a sending IP block, and the destination is a receiving IP block. Each IP block is associated with a network address, but communications in such a NOC do not include destination network addresses. Instead, each communication is fashioned with a route code that is used by routers of the NOC to guide communications through the NOC from a source to a destination. In formulating inter-IP block communications, an application program (190 on FIG. 4) provides each communication with a destination network address and then sends the communication to the network interface controller (108 on FIG. 4). Upon receiving such a communication from such an application program in its associated IP block, the route identification module (192 on FIG. 4) in the network interface controller operates as conversion logic to retrieve from the routing table (194), in dependence upon the destination network address for the inter-IP block communication, a route code identifying a route through the network to the destination network address for inclusion in the inter-IP block communication.

Exemplary embodiments of the present invention are described largely in the context of a fully functional computer system for data processing with a NOC. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A network on chip (‘NOC’) comprising:
integrated processor (‘IP’) blocks, routers, memory communications controllers, and network interface controllers, each IP block adapted to a router through a memory communications controller and a network interface controller, each memory communications controller controlling communications between an IP block and memory, and each network interface controller controlling inter-IP block communications through routers,
wherein all communications include a route code specifying a route through the routers of the NOC from a source to a destination, and each router comprises routing logic that directs a communication to one of four ports of the router, the one port identified by the first two bits in the route code, and shifts the route code to discard the first two bits of the route code before transmitting the communication through the one port.

2. The NOC of claim 1 wherein each IP block further comprises:
a routing table and a route identification module,
the routing table associating route codes and destination network addresses,
the route identification module operating to accept a destination network address for a communication from an application program executing on the IP block, find a route code for the communication in the routing table, and return the route code to the application program for inclusion in a communication.

3. The NOC of claim 1 wherein each network interface controller comprises:
a routing table that associates destination network addresses and route codes; and
conversion logic that operates to retrieve from the routing table, in dependence upon a destination network address for an inter-IP block communication, a route code identifying a route through the network to the destination network address for inclusion in the inter-IP block communication.

4. The NOC of claim 1 wherein each network interface controller comprises:
a memory address conversion table that associates memory addresses and route codes; and
conversion logic that operates to retrieve from the memory address conversion table, in dependence upon a memory address for a communication between an IP block and memory, a route code identifying a route through the network to the memory address.

5. The NOC of claim 1 wherein the memory communications controller comprises:
a plurality of memory communications execution engines, each memory communications execution engine enabled to execute a complete memory communications instruction separately and in parallel with other memory communications execution engines; and
bidirectional memory communications instruction flow between the network and the IP block.

6. The NOC of claim 1 wherein each IP block comprises a reusable unit of synchronous or asynchronous logic design used as a building block for data processing within the NOC.

7. The NOC of claim 1 wherein each router comprises two or more virtual communications channels, each virtual communications channel characterized by a communication type.

8. The NOC of claim 1 wherein each network interface controller is enabled to:
convert communications instructions from command format to network packet format; and
implement virtual channels on the network, characterizing network packets by type.

9. The NOC of claim 1 wherein each IP block is enabled to send memory-address-based communications to and from memory through the IP block's memory communications controller and then also through the IP block's network interface controller to the network.

10. The NOC of claim 1 wherein each IP block is enabled to bypass the IP block's memory communications controller and send inter-IP block communications directly to the network through the IP block's network interface controller.

11. A method of data processing with a network on chip (‘NoC’), the NOC comprising IP blocks, routers, memory communications controllers, and network interface controllers, and each IP block adapted to a router through a memory communications controller and a network interface controller, the method comprising:
controlling by each memory communications controller communications between an IP block and memory, and
controlling by each network interface controller inter-IP block communications through routers,
wherein all communications include a route code specifying a route through the routers of the NOC from a source to a destination, and each router comprises routing logic that directs a communication to one of four ports of the router, the one port identified by the first two bits in the route code, and shifts the route code to discard the first two bits of the route code before transmitting the communication through the one port.

12. The method of claim 11 further comprising:
associating in each IP block route codes and destination network addresses in a routing table;
accepting, in an IP block by a route identification module from an application program executing on the IP block, a destination network address for a communication;
finding by the route identification module a route code for the communication in the routing table, and
returning by the route identification module the route code to the application program.

13. The method of claim 11 further comprising:
associating in each network interface controller destination network addresses and route codes in a routing table; and
retrieving from the routing table by conversion logic, in dependence upon a destination network address for an inter-IP block communication, a route code identifying a route through the network to the destination network address for inclusion in the inter-IP block communication.

14. The method of claim 11 further comprising:
associating in each network interface controller memory addresses and route codes in a memory address conversion table; and
retrieving from the memory address conversion table by conversion logic, in dependence upon a memory address for a communication between an IP block and memory, a route code identifying a route through the network to the memory address.

15. The method of claim 11 wherein the memory communications controller comprises a plurality of memory communications execution engines and controlling communications between an IP block and memory further comprises:
executing by each memory communications execution engine a complete memory communications instruction separately and in parallel with other memory communications execution engines; and
executing a bidirectional flow of memory communications instructions between the network and the IP block.

16. The method of claim 11 wherein each IP block comprises a reusable unit of synchronous or asynchronous logic design used as a building block for data processing within the NOC.

17. The method of claim 11 further comprising transmitting messages by each router through two or more virtual communications channels, each virtual communications channel characterized by a communication type.

18. The method of claim 11 wherein controlling inter-IP block communications further comprises:
converting by each network interface controller communications instructions from command format to network packet format; and
implementing by each network interface controller virtual channels on the network, characterizing network packets by type.

19. The method of claim 11 further comprising sending by each IP block memory-address-based communications to and from memory through the IP block's memory communications controller and through the IP block's network interface controller to the network.

20. The method of claim 11 further comprising sending, by each IP block, inter-IP block communications directly to the network through the IP block's network interface controller, bypassing the IP block's memory communications controller for inter-IP block communications.
